(19) United States
(12) Patent Application Publication
(10) Pub. No.: US 2011/0319545 A1
(43) Pub. Date: Dec. 29, 2011

(54) PROCESS FOR PREPARING CURABLE PERFLUOROELASTOMER COMPOSITIONS

(75) Inventor: CHRISTOPHER J. BISH, Kennett Square, PA (US)

(73) Assignee: E.I. DU PONT DE NEMOURS AND COMPANY, Wilmington, DE (US)

(21) Appl. No.: 12/823,228

(22) Filed: Jun. 25, 2010

(51) Int. Cl. C08K 3/36; B82Y 30/00

(52) U.S. Cl. 524/493; 977/773

(57) ABSTRACT

A non-black filled perfluoroelastomer composition comprising a) a perfluoroelastomer, b) 0.1-30 phr colloidal silica filler having an average particle size <100 nm, and c) a curative is made by 1) mixing an aqueous perfluoroelastomer dispersion with a sol of colloidal silica having an average particle size <100 nm, 2) isolating the perfluoroelastomer composition from the aqueous dispersion and 3) mixing the composition with curative. Cured compositions have surprisingly better compression set than do similar compounds containing hydrophilic silica.

### FIELD OF THE INVENTION

This invention relates to a process for the manufacture of perfluoroelastomer compositions comprising a) perfluoroelastomer, b) a curative and c) colloidal silica having an average particle size less than 100 nm.

### BACKGROUND OF THE INVENTION

Perfluoroelastomers have achieved outstanding commercial success and are used in a wide variety of applications in which severe environments are encountered, in particular those end uses where exposure to high temperatures and aggressive chemicals occurs. These polymers are often used in seals for aircraft engines, in oil-well drilling devices, in semiconductor wafer manufacturing processes and in sealing elements for industrial equipment used at high temperatures.

In order to achieve suitable physical properties, perfluoroelastomer compositions typically contain fillers such as carbon black or white fillers such as silica, alumina, barium sulfate and titanium dioxide.

Sealing components used in equipment for manufacture of electronic components, for example semi-conductor devices, must meet unusually stringent property requirements. Specifically, the seals are often exposed to reactive plasmas, corrosive cleaning gases and high temperatures, often up to about 300° C., that cause rapid deterioration of physical properties. Furthermore, degradation of the elastomer can release fillers, metals and other debris that may contaminate semiconductor chips.

Others have attempted to minimize contamination from fillers by employing fillers having an average primary particle size of <100 nm. See for example US 2005/0070637 A1, US 2005/0004298 A1, U.S. Pat. No. 6,803,402 B2 and U.S. Pat. No. 7,495,046 B2. However, these nano-size primary particle fillers tend to either be present in chains or to agglomerate into masses having diameters greater than 100 nm within the perfluoroelastomer composition. Thus, the benefits to physical properties and reduced contamination are less than expected.

It would be desirable to have a curable, non-black filled perfluoroelastomer composition which yields a cured article having good physical properties, including compression set resistance and which produces reduced amounts of contaminating debris when exposed to harsh environments such as reactive plasma.

### SUMMARY OF THE INVENTION

The present invention is directed to a curable perfluoroelastomer composition that, when cured, has good physical properties, particularly good (i.e. low) compression set and which produces reduced amounts of contaminating debris when exposed to harsh environments such as reactive plasma. Accordingly, an aspect of the present invention is a process for manufacture of a curable perfluoroelastomer composition comprising:
A. mixing a perfluoroelastomer aqueous dispersion with a colloidal silica sol having an average particle size. <100 nm to form an aqueous perfluoroelastomer composition;
B. isolating said perfluoroelastomer composition from said aqueous composition; and
C. mixing said perfluoroelastomer composition with a curative to form a curable perfluoroelastomer composition comprising perfluoroelastomer, 0.1 to 30 parts by weight per hundred parts by weight perfluoroelastomer, of a colloidal silica sol having an average particle size <100 nm, and 0.1 to 7 parts by weight per hundred parts by weight perfluoroelastomer, of curative.

Another aspect of the present invention is a curable perfluoroelastomer composition made by the above-described process.

Another aspect of the present invention is a cured perfluoroelastomer article made by the above-described process.

### DETAILED DESCRIPTION OF THE INVENTION

The compositions of the present invention are based on elastomeric perfluoropolymers (hereinafter “perfluoroelastomers”), that is, substantially fully fluorinated fluoropolymers which, when cured, exhibit an elastomeric character. The perfluoroelastomers contain cure sites which render the polymers crosslinkable by curatives commonly employed with perfluoroelastomers, e.g. including, but not limited to bis(aminophenols), organic peroxides, compounds that decompose to produce ammonia, organotin compounds, etc.

Compositions of the present invention are substantially free from carbon black, i.e. they contain less than 5 phr (parts by weight per hundred parts by weight rubber, i.e. perfluoroelastomer), preferably less than 0.1 phr carbon black, most preferably 0 phr carbon black.

Perfluoroelastomers are polymeric compositions having copolymerized units of at least two principal perfluorinated monomers. Generally, one of the principal comonomers is a perfluoroolefin, while the other is a perfluoro(vinyl ether). Representative perfluorinated olefins include tetrafluoroethylene (TFE) and hexafluoropropylene (HFP). Suitable perfluorinated vinyl ethers are those of the formula

CF₂═CFO(R_{f}.O)ₙ(R_{f}.O)ₘR_{f} (I)

where R_{f} and R_{f′} are different linear or branched perfluoroalkylene groups of 2-6 carbon atoms, m and n are independently 0-10, and R_{f} is a perfluoroalkyl group of 1-6 carbon atoms.

A preferred class of perfluoro(vinyl ethers) includes compositions of the formula

CF₂═CFO(CF₂CFXO)ₙR_{f} (II)
where X is F or CF₃, n is 0-5, and R_{f} is a perfluoroalkyl group of 1-6 carbon atoms.
   A most preferred class of perfluoro(vinyl ethers) includes those ethers wherein n is 0 or 1 and R_{f} contains 1-3 carbon atoms. Examples of such perfluorinated ethers include perfluoro(methyl vinyl ether) (PMVE) and perfluoro(propyl vinyl ether) (PPVE). Other useful monomers include compounds of the formula

CF₂═CFO[(CF₂)ₘCF₂CFZO]ₙR_{f} (III)
where R_{f} is a perfluoroalkyl group having 1-6 carbon atoms,
m=0 or 1, n=0-5, and Z═F or CF₃.
   Preferred members of this class are those in which R_{f} is C₃F₇, m=0, and n=1.

Additional perfluoro(vinyl ether) monomers include compounds of the formula

CF₂═CFO[(CF₂CFCF₃O)ₙ(CF₂CF₂CF₂O)ₘ(CF₂)ₚ]CₓF₂ₓ₊₁ (IV)
where m and n independently=1-10, p=0-3, and x=1-5.
   Preferred members of this class include compounds where n=0-1, m=0-1, and x=1.

Another example of a useful perfluoro(vinyl ether) includes

CF₂═CFOCF₂CF(CF₃)O(CF₂O)ₘCₙF₂ₙ₊₁ (V)
where n=1-5, m=1-3, and where, preferably, n=1.

Mixtures of perfluoro(vinyl ethers) may also be used.

Preferred perfluoroelastomers are composed of tetrafluoroethylene and at least one perfluoro(vinyl ether) as principal monomer units. In such copolymers, the copolymerized perfluorinated ether units constitute from about 15 mole percent to 65 mole percent (preferably 25 to 60 mole percent) of total monomer units in the polymer.

The perfluoroelastomer further contains copolymerized units of at least one cure site monomer, generally in amounts of from 0.1-5 mole percent. The range is preferably between 0.3-1.5 mole percent. Although more than one type of cure site monomer may be present, most commonly one cure site monomer is used and it contains at least one nitrile substituent group. Suitable cure site monomers include nitrile-containing fluorinated olefins and nitrile-containing fluorinated vinyl ethers. Useful nitrile-containing cure site monomers include those of the formulas shown below.

CF₂═CF—O(CF₂)ₙ—CN (VI)

where n=2-12, preferably 2-6;

CF₂═CF—O[CF₂—CF(CF₃)—O]ₙ—CF₂—CFCF₃—CN (VII)

where n=0-4, preferably 0-2; and

CF₂═CF—[OCF₂CF(CF₃)]_{X}—O—(CF₂)ₙ—CN (VIII)

where x=1-2, and n=1-4.

Those of formula (VIII) are preferred. Especially preferred cure site monomers are perfluorinated polyethers having a nitrile group and a trifluorovinyl ether group. A most preferred cure site monomer is

CF₂═CFOCF₂CF(CF₃)OCF₂CF₂CN (IX)

i.e. perfluoro(8-cyano-5-methyl-3,6-dioxa-1-octene) or 8-CNVE.

Other cure site monomers that may be employed in the perfluoroelastomers of this invention include olefins represented by the formula R₁CH═CR₂R₃, wherein R₁ and R₂ are independently selected from hydrogen and fluorine and R₃ is independently selected from hydrogen, fluorine, alkyl, and perfluoroalkyl. The perfluoroalkyl group may contain up to about 12 carbon atoms. However, perfluoroalkyl groups of up to 4 carbon atoms are preferred. In addition, the cure site monomer preferably has no more than three hydrogen atoms. Examples of such olefins include ethylene, vinylidene fluoride, vinyl fluoride, trifluoroethylene, 1-hydropentafluoropropene, and 2-hydropentafluoropropene, as well as brominated or iodinated olefins such as 4-bromo-3,3,4,4-tetrafluorobutene-1 and bromotrifluoroethylene.

Another type of cure site monomer which may be incorporated in the perfluoroelastomers employed in this invention is perfluoro(2-phenoxypropyl vinyl ether) and related monomers as disclosed in U.S. Pat. No. 3,467,638.

Perfluoroelastomers employed in this invention may be manufactured by such well-known processes as those described in Breazeale (U.S. Pat. No. 4,281,092) or Coughlin et. al. (U.S. Pat. No. 5,789,489).

Alternatively, or in addition to a cure site monomer, the perfluoroelastomer may contain iodine and/or bromine atoms at terminal positions on the perfluoroelastomer polymer chains. Such atoms may be introduced during polymerization by reaction of an iodine or bromine-containing chain transfer agent as described in U.S. Pat. No. 4,243,770.

The perfluoroelastomers employed in this invention preferably comprise copolymerized units of i) 38.5 to 74.7 (most preferably 44 to 69.5) mole percent tetrafluoroethylene (TFE), ii) 25 to 60 (most preferably 30 to 55) mole percent perfluoro(methyl vinyl ether) (PMVE) and iii) 0.3 to 1.5 (most preferably 0.5 to 1.0) mole percent of a nitrile group—containing cure monomer, preferably 8-CNVE.

When the perfluoroelastomer has copolymerized units of a nitrile-containing cure site monomer, a cure system based on an organotin compound can be utilized. Suitable organotin compounds include allyl-, propargyl-, triphenyl- and allenyl tin curatives. Tetraalkyltin compounds or tetraaryltin compounds are preferred curing agents for use in conjunction with nitrile-substituted cure sites. The amount of curing agent employed will necessarily depend on the degree of crosslinking desired in the final product as well as the type and concentration of reactive moieties in the perfluoroelastomer. In general, about 0.5-10 parts by weight per 100 parts elastomer (phr) of curing agent can be used, and 1-4 phr is satisfactory for most purposes. It is believed that the nitrile groups trimerize to form s-triazine rings in the presence of curing agents such as organotin, thereby crosslinking the perfluoroelastomer. The crosslinks are thermally stable, even at temperatures of 275° C. and above. A preferred cure system, useful for perfluoroelastomers containing nitrile-containing cure sites, utilizes bis(aminophenols) and bis(aminothiophenols) of the formulas

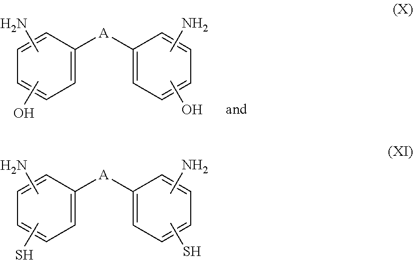

and tetraamines of the formula

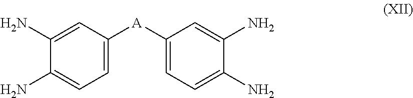

where A is SO₂, O, CO, alkylene of 1-6 carbon atoms, perfluoroalkylene of 1-10 carbon atoms, or a carbon-carbon bond linking the two aromatic rings. The amino and hydroxyl or thio groups in formulas X and XI above are adjacent to each other on the benzene rings and are interchangeably in the meta and para positions with respect to the group A. Preferably, the curing agent is a compound selected from the group consisting of 4,4′-[2,2,2-trifluoro-1-(trifluoromethyl)ethylidene]bis(2-aminophenol); 4,4′-sulfonylbis(2-aminophenol); 3,3′-diaminobenzidine; and 3,3′,4,4′-tetraminobenzophenone. The first of these is the most preferred and will be referred to as bis(aminophenol) AF (or DABPAF). The curing agents can be prepared as disclosed in U.S. Pat. No. 3,332,907 to Angelo. Bis(aminophenol) AF can be prepared by nitration of 4,4′-[2,2,2-trifluoro-1-(trifluoromethyl)ethylidene]-bisphenol (i.e. bisphenol AF), preferably with potassium nitrate and trifluoroacetic acid, followed by catalytic hydrogenation, preferably with ethanol as a solvent and a catalytic amount of palladium on carbon as catalyst. The level of curing agent should be chosen to optimize the desired properties of the vulcanizate. In general, a slight excess of curing agent over the amount required to react with all the cure sites present in the perfluoroelastomer is used. Typically, 0.5-5 parts by weight of the curative per 100 parts of elastomer is required. The preferred range is 1-2 phr.

Peroxides may also be utilized as curing agents, particularly when the cures site is a nitrile, an iodine or bromine group. Useful peroxides are those which generate free radicals at curing temperatures. A dialkyl peroxide or a bis(dialkyl peroxide) which decomposes at a temperature above 50° C. is especially preferred. In many cases it is preferred to use a ditertiarybutyl peroxide having a tertiary carbon atom attached to peroxy oxygen. Among the most useful peroxides of this type are 2,5-dimethyl-2,5-di(tertiarybutylperoxy)hexyne-3 and 2,5-dimethyl-2,5-di(tertiarybutylperoxy)hexane. Other peroxides can be selected from such compounds as dicumyl peroxide, dibenzoyl peroxide, tertiarybutyl perbenzoate, and di[1,3-dimethyl-3-(t-butylperoxy)butyl]carbonate. Generally, about 1-3 parts of peroxide per 100 parts of perfluoroelastomer is used. Another material which is usually blended with the composition as a part of the peroxide curative system is a coagent composed of a polyunsaturated compound which is capable of cooperating with the peroxide to provide a useful cure. These coagents can be added in an amount between 0.1 and 10 parts per 100 parts perfluoroelastomer, preferably between 2-5 phr. The coagent may be one or more of the following compounds: triallyl cyanurate; triallyl isocyanurate; tri(methylallyl)isocyanurate; tris(diallylamine)-s-triazine; triallyl phosphite; N,N-diallyl acrylamide; hexaallyl phosphoramide; N,N,N′,N′-tetraalkyl tetraphthalamide; N,N,N′,N′-tetraallylmalonamide; trivinyl isocyanurate; 2,4,6-trivinyl methyltrisiloxane; and tri(5-norbornene-2-methylene)cyanurate. Particularly useful is triallyl isocyanurate. Other curatives suitable for vulcanizing perfluoroelastomers having nitrile cure sites include nitrogen-containing nucleophilic compounds (e.g. diphenylguanidine) as disclosed in U.S. Pat. No. 6,638,999 B2, ammonia, the ammonium salts of inorganic or organic acids (e.g. ammonium perfluorooctanoate) as disclosed in U.S. Pat. No. 5,565,512, and compounds (e.g. urea) which decompose at curing temperatures to produce ammonia as disclosed in U.S. Pat. No. 6,281,296 B1.

Bis(aminophenol) AF is the preferred curative employed in this invention.

Depending on the cure sites present, it is also possible to use a dual cure system. For example, perfluoroelastomers having copolymerized units of nitrile-containing cure site monomers can be cured using a curative comprising a mixture of a peroxide in combination with an organotin curative and a coagent. Generally, 0.3-5 parts of peroxide, 0.3-5 parts of coagent, and 0.1-10 parts of organotin curative are utilized.

The compositions of the present invention also contain 0.1 to 30 (preferably 5 to 15) phr colloidal silica having an average particle size less than 100 nm. By “colloidal silica” is meant monodispersed silicon dioxide particles having particle sizes between about 5 and 100 nm, usually present in an aqueous suspension. Commercially available colloidal silicas are in the form of sols, e.g. Snowtex® MP1040 (Nissan Chemical Industries, Ltd.) and Ludox® HS40, TM 50, AS 40 or AS 30 (DuPont).

In the process of the invention for manufacture of curable perfluoroelastomer compositions, it is important, in order to achieve intimate mixing, that the perfluoroelastomer be in the form of an aqueous dispersion when it is mixed with the colloidal silica sol. The perfluoroelastomer aqueous dispersion may be taken directly from the polymerization process, prior to coagulation.

After an aqueous dispersion of perfluoroelastomer and colloidal silica has been formed, the solids are isolated from the dispersion by coagulation, followed by separation of solution from the perfluoroelastomer/colloidal silica composition. Separation may be by conventional means, e.g. filtration, centrifugation, etc. The resulting composition is typically dried in an oven, typically overnight at 130° C.

Isolated perfluoroelastomer composition containing colloidal silica is typically mixed on conventional rubber equipment (e.g. a 2-roll mill) with curative and any other optional ingredients to form a curable composition:

Additives, such as stabilizers, plasticizers, lubricants, other fillers, and processing aids typically utilized in perfluoroelastomer compounding may optionally be incorporated into the compositions of the present invention, provided they have adequate stability for the intended service conditions.

Cured perfluoroelastomer articles are made by optionally, first shaping the curable composition and then initiating crosslinking of the elastomer. Initiation is typically by heat, e.g. 170° to 220° C. for 1 to 20 minutes. Optionally, the articles may be further cured (i.e. post cured) in an oven at a temperature between 270° and 330° C. for 1 to 48 hours.

The curable compositions of the present invention are useful in production of gaskets, tubing, and seals. Such articles are generally produced by molding a compounded formulation of the curable composition with various additives under pressure, curing the part, and then subjecting it to a post cure cycle. The cured compositions have excellent physical properties, including compressions set. They are particularly useful in applications such as seals and gaskets for manufacturing semiconductor devices.

The invention is now illustrated by certain embodiments wherein all parts are by weight unless otherwise specified.

### EXAMPLES

### Test Methods

### Cure Characteristics

Cure characteristics were measured using a Monsanto Moving Die

Rheometer (MDR 2000) instrument under the following conditions:

Moving die frequency: 1.66 Hz

Oscillation amplitude: 0.5

Temperature: As specified in the Examples

Duration of test: As specified in the Examples
The following cure parameters were recorded:

M_{H}: maximum torque level, in units of dN·m

M_{L}: minimum torque level, in units of dN·m

tₛ2: minutes to 2 units rise above M_{L}

t_{c}90: minutes to 90% of maximum torque

Test specimens were prepared from elastomer compounded with appropriate additives, as described in the formulations listed in the Examples below. Compounding was carried out on a rubber mill. The milled composition was formed into a sheet and a sample was died out into a disk to form the test specimen.

Cure characteristics were determined by placing a test specimen in the sealed test cavity of the instrument which was maintained under a positive pressure and elevated temperature. A biconical disk was embedded in the test specimen and was oscillated through an arc of 0.5° at the specified frequency, thereby exerting a shear strain on the test specimen. The force at maximum amplitude (torque) required to rotate the disk is proportional to the stiffness (shear modulus) of the rubber. This torque was recorded as a function of time. Because stiffness of a rubber specimen increases during curing, the test provides a measure of curability. A test is completed when a predetermined time has elapsed. The time required to obtain a curve is a function of the test temperature and the characteristics of the rubber compound.

### Tensile Properties

Unless otherwise noted, stress/strain properties were measured on dumbbells. Physical property measurements were obtained according to methods described in ASTM D412. The following parameters were recorded:

M₁₀₀, modulus at 100% elongation in units of MPa

T_{B}, tensile strength at break in units of MPa.

E_{B}, elongation at break in units of %

Compression set of O-ring samples was determined in accordance with ASTM D395.

### Plasma Resistance Testing

Sections of o-rings being tested were placed on a 6-inch wafer located at the center of a parallel plate (RIE) etching chamber. Plasma resistance was measured under two different conditions, Physical (or Chemical), and with two different plasmas:

| | | |
|---|---|---|
| Gas | NF₃/Ar | O₂ |

| Flow Rate (sccm¹) | 13/37 | | 50 | |
|---|---|---|---|---|
| Power (W) | 900 | (200) | 900 | (200) |
| Pressure (Pa) | 31 | (67) | 13 | (67) |
| Time (hour) | 1 | (6) | 1 | (6) |

¹sccm is standard cubic centimeters per minute

Percent Weight Loss was determined by measuring the weight of the o-ring section being tested before and after exposure to plasma

Particle Generation (particles per mm² surface area of o-ring) was measured using o-rings that were exposed to NF₃/Ar or O₂ plasma under the above conditions. Particles were shaken free from the o-ring surface by ultrasonication and collected. The collected particles were measured by an APSS/Liquilaz (Particle Measuring Systems) and are reported as number per mm² surface area.

The following perfluoroelastomer polymer was used in the Examples:

FFKM—A terpolymer containing 68.2 mole percent units of TFE, 31.0 mole percent units of PMVE and 0.80 mole percent units of 8-CNVE was prepared according to the general process described in U.S. Pat. No. 5,789,489.

### Control Examples 1-3 and Examples 1 and 2

Control compositions of diamino(bisphenol) AF (DABPAF) curable perfluoroelastomer compositions containing various amounts of a non-colloidal (i.e. fumed) silica having primary particle size of about 12 nm, present in chains, aggregates or agglomerates (Aerosil 200vs, available from Degussa) were mixed on a 2-roll mill. The formulations are shown in Table I.

Sample compositions of the invention were made by the process of the invention wherein an aqueous dispersion of perfluoroelastomer (containing 29.3 wt % perfluoroelastomer solids) was mixed with Nissan MP 1040 silica sol (containing 40.7 wt % silica solids). The pH of the latter sol was adjusted to pH 9 with 5% NaOH prior to mixing with perfluoroelastomer. The resulting composition was isolated by first coagulating by addition of aluminum sulfate, then filtering and washing with deionized water: Curative was added to the composition on a 2-roll rubber mill. The formulations are shown in Table I.

Curing characteristics were measured at 199° C. for 10 minutes. O-rings were molded at 199° C. for 50 minutes and then post cured in an oven under nitrogen at 305° C. for 26 hours, after a slow ramp up to 305° C. Tensile properties and compression set of o-rings were then measured according to the Test Methods. The results are shown in Table I.

TABLE I

| | Control | Control | Control | | |
|---|---|---|---|---|---|
| | Example 1 | Example 2 | Example 3 | Example 1 | Example 2 |
| Formulation (phr) | | | | | |
| FFKM | 100 | 100 | 100 | 0 | 0 |
| Aerosil ® 200 VS¹ | 5 | 10 | 15 | 0 | 0 |
| FFKM + 10 phr | 0 | 0 | 0 | 100 | 0 |
| Nissan MP1040 | | | | | |
| FFKM + 15 phr | 0 | 0 | 0 | 0 | 100 |
| Nissan MP1040 | | | | | |
| DABPAF² | 1.75 | 1.75 | 1.75 | 1.75 | 1.75 |
| Tensile Properties | | | | | |
| M₁₀₀ (MPa) | 4.2 | 9.1 | 13.9 | 3.8 | 7.3 |
| T_{B} (MPa) | 15.0 | 17.1 | 16.9 | 15.4 | 20.1 |
| E_{B} (%) | 202 | 170 | 121 | 193 | 157 |
| Hardness, Shore A | 66 | 76 | 85 | 64 | 69 |
| Compression Set | 29.4 | 48.6 | 60.0 | 17.7 | 17.7 |
| @ 204° C., 70 hours | | | | | |
| Cure Characteristics | | | | | |
| ML (dN · m) | 2.5 | 3.85 | 7.04 | 2.14 | 2.61 |
| MH (dN · m) | 11.09 | 14.46 | 22.89 | 7.67 | 9.29 |
| Ts2 (minutes) | 3.46 | 2.56 | 1.17 | 7368 | 6.32 |
| Tc90 (minutes) | 7.79 | 9.08 | 9.81 | 24.4 | 24.4 |

¹hydrophilic silica (available from Degussa Aktiengesellschaft)
²diamino(bisphenol) AF

O-ring specimens from Control 2 and from Example 1 of the invention were exposed to NF₃/Ar plasma and to O₂ plasma. Percent weight loss and number of particles generated per mm² were measured according to the Test Methods. Results are shown in Table II.

TABLE II

| NF₃/Ar | | | | | O₂ | | | |
|---|---|---|---|---|---|---|---|---|
| Chemical | | | Physical | | Chemical | | Physical | |
| | | # of | | # of | | # of | | # of |
| | % wt | particles/ | % wt | particles/ | % wt | particles/ | % wt | particles/ |
| Specimen | loss | mm² | loss | mm² | loss | mm² | loss | mm² |
| Control Ex. 2 | 0.27 | 3095 | 2.06 | 30497 | 1.09 | 16301 | 1.43 | 21128 |
| Example 1 | 0.58 | 4298 | 1.53 | 7093 | 0.40 | 6664 | 1.30 | 20206 |

What is claimed is:

1. A process for manufacture of a curable perfluoroelastomer composition comprising:
A. mixing a perfluoroelastomer aqueous dispersion with a colloidal silica sol having an average particle size <100 nm to form an aqueous perfluoroelastomer composition;
B. isolating said perfluoroelastomer composition from said aqueous composition; and
C. mixing said perfluoroelastomer composition with a curative to form a curable perfluoroelastomer composition comprising perfluoroelastomer, 0.1 to 30 parts by weight per hundred parts by weight perfluoroelastomer, of a colloidal silica sol having an average particle size <100 nm, and 0.1 to 7 parts by weight per hundred parts by weight perfluoroelastomer, of curative.

2. A process of claim 1 wherein said colloidal silica sol is present at a level of 5 to 15 parts by weight per hundred parts by weight perfluoroelastomer.

3. A process of claim 1 wherein said curative is bis(aminophenol) AF.

4. A curable perfluoroelastomer composition made by a process for manufacture of a curable perfluoroelastomer composition comprising:
A. mixing a perfluoroelastomer aqueous dispersion with a colloidal silica sol having an average particle size <100 nm to form an aqueous perfluoroelastomer composition;
B. isolating said perfluoroelastomer composition from said aqueous composition; and
C. mixing said perfluoroelastomer composition with a curative to form a curable perfluoroelastomer composition comprising perfluoroelastomer, 0.1 to 30 parts by weight per hundred parts by weight perfluoroelastomer, of a colloidal silica sol having an average particle size <100 nm, and 0.1 to 7 parts by weight per hundred parts by weight perfluoroelastomer, of curative.

5. A curable perfluoroelastomer composition of claim 4 wherein said colloidal silica sol is present at a level of 5 to 15 parts by weight per hundred parts by weight perfluoroelastomer.

6. A curable perfluoroelastomer composition of claim 4 wherein said curative is bis(aminophenol) AF.

7. A cured perfluoroelastomer article made by a process for manufacture of a curable perfluoroelastomer composition comprising:
A. mixing a perfluoroelastomer aqueous dispersion with a colloidal silica sol having an average particle size <100 nm to form an aqueous perfluoroelastomer composition;
B. isolating said perfluoroelastomer composition from said aqueous composition;
C. mixing said perfluoroelastomer composition with a curative to form a curable perfluoroelastomer composition comprising perfluoroelastomer, 0.1 to 30 parts by weight per hundred parts by weight perfluoroelastomer, of a colloidal silica sol having an average particle size <100 nm, and 0.1 to 7 parts by weight per hundred parts by weight perfluoroelastomer, of curative; and
D. crosslinking said curable perfluoroelastomer composition to form a cured article.

8. A cured perfluoroelastomer article of claim 7 wherein said colloidal silica sol is present at a level of 5 to 15 parts by weight per hundred parts by weight perfluoroelastomer.

9. A cured perfluoroelastomer article of claim 7 wherein said curative is bis(aminophenol) AF.
